(19) United States
(12) Patent Application Publication
(10) Pub. No.: US 2023/0155461 A1
(43) Pub. Date: May 18, 2023

(54) CONDUCTOR FORMING DEVICE AND METHOD OF MANUFACTURING WAVE WINDING COIL

(71) Applicant: HONDA MOTOR CO., LTD., Tokyo (JP)

(72) Inventors: Yosuke HONDA, Tokyo (JP); Dai SASAKI, Tokyo (JP); Mikito SAITO, Tokyo (JP)

(21) Appl. No.: 18/055,419

(22) Filed: Nov. 15, 2022

(30) Foreign Application Priority Data
Nov. 18, 2021 (JP) 2021-187725

(51) Int. Cl. H02K 15/04; B21F 3/00

(52) U.S. Cl. CPC H02K 15/0478; B21F 3/00

(57) ABSTRACT

A conductor forming device which folds a group of conductors in thickness directions, the group of conductors including a plurality of conductors having straight parts, includes a restrainer provided with a plurality of grooves in which fold parts of the conductors each consisting of at least two unit wires are fitted and which limit a width of each of the conductors to a predetermined distance, when the conductors each consisting of the at least two unit wires are to be folded.

This application is based on and claims the benefit of priority from Japanese Patent Application No. 2021-187725, filed on 18 Nov. 2021, the content of which is incorporated herein by reference.

### BACKGROUND OF THE INVENTION

### Field of the Invention

The present invention relates to a conductor forming device and a method of manufacturing a wave winding coil.

### Related Art

A wave winding coil is generally known as a coil included in a stator for a rotary electric machine such as an electric motor and an electric generator that can reduce environmental burden by reduction of CO, emissions. A wave winding coil has a plurality of straight-shaped, in-slot disposition parts to be disposed in slots of a stator core and a plurality of turning parts (fold parts) each coupling, on an outer side of the stator core in an axial direction, the in-slot disposition parts adjacent to each other in a V or inverted V shape or an arch shape, and is formed into a wave shape along a circumferential direction of the stator core.

As such a wave winding coil, there is known a long sheet-shaped wave winding coil having a length that is two or more times the length of the circumference of the stator core. The sheet-shaped wave winding coil is spirally wound, and each in-slot disposition part is inserted into a corresponding slot of the stator core, whereby a coil having a plurality of layers (a plurality of turns) is formed. The sheet-shaped wave winding coil can be formed into a strip shape without the necessity of welding, and therefore can be reduced in weight in comparison with segment coils requiring welding.

There is a known method of manufacturing such a sheet-shaped wave winding coil, according to which all of a plurality of inclined-shaped crossover conductors corresponding to the turning parts of the wave winding coil and a plurality of straight-shaped slot conductors corresponding to the in-slot disposition parts of the wave winding coil are formed beforehand in a coil conductor within a plane on which the coil conductor extends, and thereafter, the crossover conductors are sequentially folded at their centers, whereby the resultant fold parts constitute the turning parts of the wave winding coil (for example, see Japanese Unexamined Patent Application, Publication No. 2021-58076). The turning part of the wave winding coil disclosed in Japanese Unexamined Patent Application, Publication No. 2021-58076 is a conductor consisting of at least two unit wires.
Patent Document 1: Japanese Unexamined Patent Application, Publication No. 2021-58076

### SUMMARY OF THE INVENTION

However, with the above-described known technique, when the turning parts each consisting of two or more unit wires are bent at the same time, twists occur near apex parts formed after bending the turning parts in the respective coil wires (the conductors) arranged in parallel to each other, and variations in individual shapes are caused, in the wave winding coil to be formed due to the influence of the twists, which may adversely affect the workability particularly when automated work is performed.

An object of the present invention is to provide a conductor forming device that makes it possible to prevent a twist from occurring at an apex part of a fold part of a conductor while achieving reduction in weight, and a method of manufacturing a wave winding coil.

A first aspect of the present invention is directed to a conductor forming device (e.g., a conductor forming device 200, which will be described later) which folds a group of conductors (e.g., a group of conductors 100, which will be described later) in thickness directions, the group of conductors including a plurality of conductors (e.g., coil wires 10, which will be described later) having straight parts (e.g., straight parts 14, which will be described later). The conductor forming device includes a restrainer (e.g., a restrainer 225, which will be described later) provided with a plurality of grooves (e.g., grooves 225a, which will be described later) in which fold parts (e.g., turning parts 12, which will be described later) of the conductors each consisting of at least two unit wires (e.g., unit wires 10a, which will be described later) are fitted and which limit a width of each of the conductors to a predetermined distance, when the conductors each consisting of the at least two unit wires are to be folded.

The first aspect makes it possible to prevent a twist from occurring near the apex parts after bending the conductors arranged in parallel to each other, and to form the wave winding coil in a uniform state. The first aspect enables improvement of the quality, and improvement of the workability of operations (e.g., straight conveyance, turning conveyance, attachment of jig, and fitting into the slots of the stator) until the completion of fitting of the wave winding coil into the slots of the stator.

A second aspect is an embodiment if the first aspect. In the conductor forming device according to the second aspect, the plurality of grooves are arranged in parallel to each other at predetermined intervals in correspondence with the plurality of conductors disposed to be formed at the same time.

According to the second aspect, when the plurality of conductors are to be formed at the same time, the plurality of fold parts disposed to be formed at the same time can be arranged in parallel to each other at the predetermined intervals in corresponding with the plurality of grooves, which makes it possible to prevent a twist from occurring, and to form the wave winding coil in a uniform state.

A third aspect of the present invention is directed to a method of manufacturing a wave winding coil from coil wire (e.g., a coil wire 10, which will be described later), the wave winding coil including a plurality of in-slot disposition parts (e.g., in-slot disposition parts 11, which will be described later) to be disposed in slots (e.g., slots 23, which will be described later) of a stator core (e.g., a stator core 20, which will be described later), and a turning part (e.g., a turning part 12, which will be described later) that couples the in-slot disposition parts adjacent to each other. The method includes a folding step of forming the turning part by folding two or more unit wires (e.g., unit wires 10a, which will be described later) at the same time in a state where a width of an apex part (e.g., an apex part 12c, which will be described later) of the turning part consisting of the at least two unit wires is limited to a predetermined distance.

The third aspect makes it possible to prevent a twist from occurring near the apex parts after bending the conductors arranged in parallel to each other, and to form the wave winding coil in a uniform state. The third aspect enables improvement of the quality, and improvement of the workability of operations (e.g., straight conveyance, turning conveyance, attachment of jig, and fitting into the slots of the stator) until the completion of fitting of the wave winding coil into the slots of the stator.

A fourth aspect is an embodiment of the third aspect. In the method of manufacturing a wave winding coil according to the fourth aspect, in the folding step, the plurality of turning parts disposed to be formed at the same time are arranged in parallel to each other at predetermined intervals.

According to the fourth aspect, the plurality of turning parts disposed to be formed at the same time are arranged in parallel to each other at the predetermined intervals, which makes it possible to prevent a twist from occurring, and to form the wave winding coil in a uniform state.

The present invention provides a conductor forming device that makes it possible to prevent a twist from occurring at an apex part of a fold part of a conductor while achieving reduction in weight, and a method of manufacturing a wave winding coil.

### BRIEF DESCRIPTION OF THE DRAWINGS

FIG. 1 is a front view schematically illustrating a wave winding coil;

FIG. 2 is a plan view schematically illustrating a stator;

FIG. 3 is a diagram illustrating how a coil wire (conductor) is formed;

FIG. 4 is a cross-sectional view taken along line A-A in FIG. 3;

FIG. 5 is a front view illustrating a part of the coil wire (conductor) in an enlarged manner;

FIG. 6 is a diagram when the coil wire (conductor) illustrated in FIG. 5 is seen in a direction along Z directions;

FIG. 7 is a front view illustrating, in an enlarged manner, a part of a group of conductors in which the plurality of coil wires (conductors) illustrated in FIG. 5 are arranged in parallel to each other;

FIG. 8 is a view when the group of conductors illustrated in FIG. 7 is seen in the direction along the Z directions;

FIG. 9 is a plan view schematically illustrating an outline of a conductor forming device;

FIG. 10 is a side view schematically illustrating the outline of the conductor forming device;

FIG. 11 is a diagram illustrating a state where clamp parts of the conductor forming device have unclamped the group of conductors;

FIG. 12 is a diagram illustrating a state where the clamp parts of the conductor forming device have clamped the group of conductors;

FIG. 13 is a plan view of the conductor forming device, illustrating a situation where the group of conductors is conveyed to a position where inclined parts are to be formed;

FIG. 14 is a side view of the conductor forming device, illustrating the situation where the group of conductors is conveyed to the position where inclined parts are to be formed;

FIG. 15 is a plan view of the conductor forming device, illustrating a situation where inclined parts are being formed on the group of conductors;

FIG. 16 is a plan view illustrating an operation of the clamp parts when the inclined parts are being formed on the group of conductors;

FIG. 17 is a plan view illustrating the inclined part of the conductor after the inclined part is formed;

FIG. 18 is a plan view of the conductor forming device, illustrating a situation where the group of conductors formed with the inclined parts is conveyed to a folding position;

FIG. 19 is a plan view of the conductor forming device, illustrating a situation where next inclined parts are being formed on the group of conductors after the inclined parts are formed;

FIG. 20 is a side view illustrating an operation of the clamp parts when the inclined parts formed on the group of conductors are being folded;

FIG. 21 is a plan view of the conductor forming device, illustrating a situation where inclined parts formed on the group of conductors are folded;

FIG. 22 is a perspective view illustrating a restrainer;

FIG. 23 is a diagram illustrating a state where a turning part of the coil wire (the conductor) consisting of three unit wires is folded in a groove of the restrainer;

FIG. 24 is a plan view illustrating the group of conductors after the inclined parts are folded;

FIG. 25 is a diagram illustrating an operation of the clamp parts after the inclined parts are folded;

FIG. 26 is a side view illustrating an operation of pressing the folded part with pressing members after the inclined parts are folded;

FIG. 27 is a plan view of the conductor forming device, illustrating a situation where next inclined parts are being formed on the group of conductors after the inclined parts are folded;

FIG. 28 is a plan view of the group of conductors, illustrating a situation where the inclined parts corresponding to layer switching parts are being folded back in an opposite direction; and

FIG. 29 is a plan view illustrating a sheet-shaped, wave winding coil formed from the group of conductors where the layer switching parts are folded back in the opposite direction.

### DETAILED DESCRIPTION OF THE INVENTION

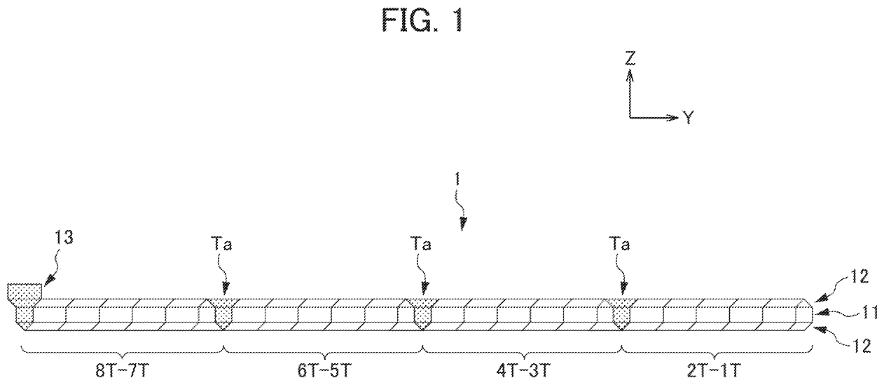

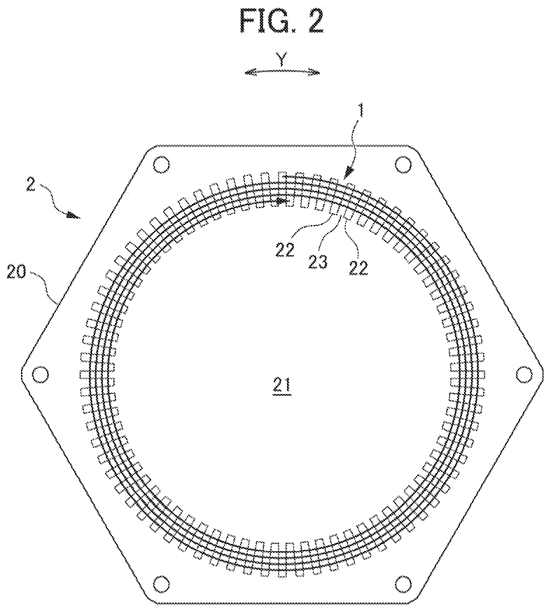

Hereinafter, a method of manufacturing a wave winding coil using a conductor forming device will be described in detail with reference to the accompanying drawings. A wave winding coil and a stator will be first described with reference to FIGS. 1 and 2. A wave winding coil 1 according to the present embodiment is formed, using a plurality of coil wires 10 arranged in parallel to each other, which will be described later, into a long sheet shape extending in Y directions in the figure. The Y directions correspond to circumferential directions of a stator core 20 illustrated in FIG. 2.

A stator 2 includes the stator core 20 and the wave winding coil 1 to be attached to the stator core 20. The stator core 20 has a plurality of teeth 22 radially protruding toward a central axial hole 21. Slots 23 are each formed between the teeth 22 and 22 adjacent to each other. The present embodiment exemplifies the stator core 20 having the seventy-two slots 23.

The wave winding coil 1 has a plurality of in-slot disposition parts 11 and a plurality of turning parts 12. The in-slot disposition parts 11 are portions to be disposed in the slots 23 of the stator core 20, and extend straightforwardly in axial directions (Z directions in FIG. 1) of the stator core 20. The turning parts 12 are each a portion coupling, on an outer side in the axial directions of the stator core 20, the in-slot disposition parts 11 and 11 adjacent to each other of the coil wires 10 in a V or inverted V shape or an arch shape. The wave winding coil 1 has, at one end, a terminal part 13 for use for electrical connection with a driving circuit. Note that, although the in-slot disposition parts 11 and the turning parts 12 of the wave winding coil 1 are formed from the plurality of coil wires 10, FIG. 1 schematically illustrates the in-slot disposition parts 11, the turning parts 12, and the terminal part 13 in plane.

The wave winding coil 1 according to the present embodiment has a length corresponding to four turns around the stator core 20, and forms a coil having eight layers (eight turns) 1T to 8T in total, on the stator core 20. Therefore, the wave winding coil 1 forms a coil having two layers (two turns) per turn around the stator core 20, in which layer switching occurs each time the coil is wound around the stator core 20. Reference signs Ta in FIG. 1 indicate layer switching parts disposed between the seventh layer (7T) and the sixth layer (6T), between the fifth layer (5T) and the fourth layer (4T), and between the third layer (3T) and the second layer (2T), respectively.

The wave winding coil 1 is spirally wound in four turns around the stator core 20, and is attached to the stator core 20 by disposing the in-slot disposition parts 11 in the slots 23 of the stator core 20. As a result, the stator 2 is formed. Note that, although an insulator is disposed in each of the slots 23 for insulating the wave winding coil 1 and the stator core 20 from each other, the insulator is not illustrated in FIG. 2.

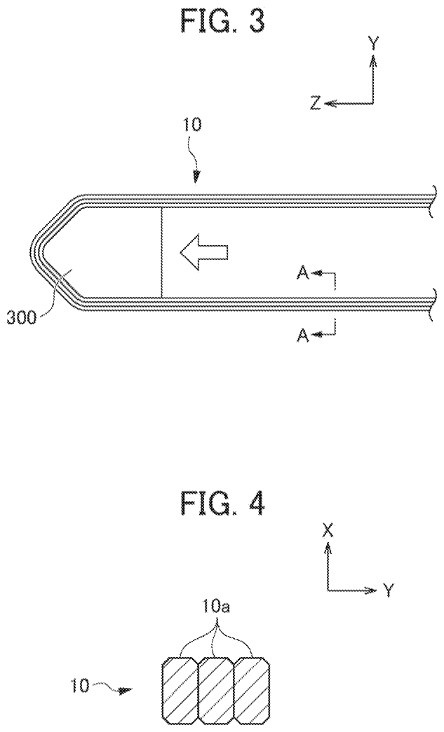

Next, each of the coil wires 10 according to an embodiment, which form the wave winding coil 1 will described with reference to FIGS. 3 to 6. The coil wire 10 is an electrical conductor made from a copper wire or the like. The coil wire 10 is first cut into a predetermined length, and then is bent at a substantially center portion in extending directions of the coil wire 10, using an extracting tool 300 that moves in a direction indicated by a white hollow arrow, as illustrated in FIG. 3. As illustrated in FIG. 4, the coil wire 10 according to the present embodiment includes three unit wires 10a that are flat wires and are arranged in the Y directions corresponding to the circumferential directions of the stator core 20. The coil wire 10 is formed by, in a state in which the three unit wires 10a are arranged in the Y directions, integrally bending the three unit wires 10a in the arrangement directions using the extracting tool 300.

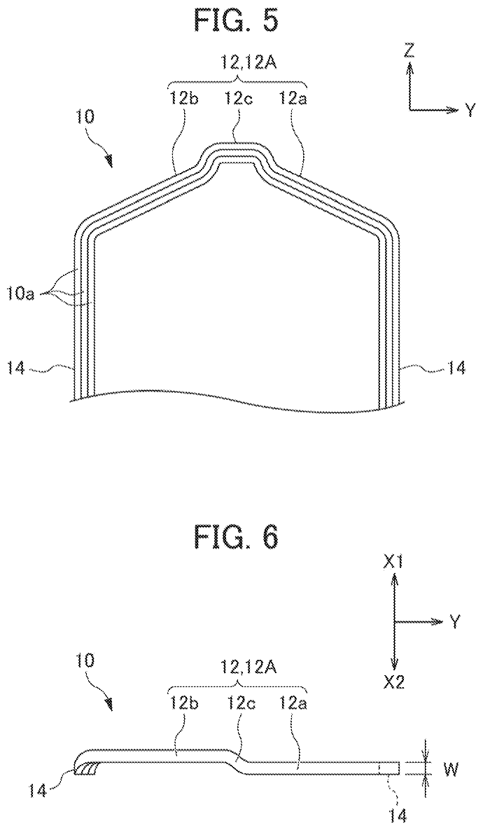

As illustrated in FIGS. 5 and 6, the coil wire 10 bent using the extracting tool 300 is formed, using a forming die (not shown), into a substantial U-shape having a turning part 12 with a V or inverted V shape (hereinafter, the turning part 12 first formed in the coil wire 10 may be referred to as a first turning part 12A) and two straight parts 14 and 14 extending in parallel to each other in the same direction from both ends of the first turning part 12A. An interval between the two straight parts 14 and 14 of the coil wire 10 according to the present embodiment corresponds to an interval between two slots 23 and 23 which are separated from each other by six slots in the stator core 20.

The first turning part 12A of the coil wire 10 has a first inclined part 12a, a second inclined part 12b, and an apex part 12c, as illustrated in FIGS. 5 and 6. The first inclined part 12a and the second inclined part 12b are integrally coupled to the straight parts 14 and 14, respectively, obliquely extend from the respective coupling portions of the straight parts 14 and 14 in directions in which the first inclined part 12a and the second inclined part 12b come closer to each other, and are then further integrally coupled to the apex part 12c.

As illustrated in FIG. 6, a wire width (a width in the radial direction of the stator core 20) of the coil wire 10 is denoted by W. The first inclined part 12a extends obliquely toward the apex part 12c with respect to the straight part 14 to which the first inclined part 12a is coupled, without being offset in the X directions. On the other hand, the second inclined part 12b is offset by W in an X1 direction with respect to the first inclined part 12a, and then obliquely extends toward the corresponding straight part 14, so that the second inclined part 12b is offset, at the coupling portion with the straight part 14, by W in an X2 direction that is an opposite direction to the X1 direction described above. As a result, the two straight parts 14 and 14 are at the same position in terms of the X directions. That is, the two straight parts 14 and 14 are disposed within a single plane extending in the Y directions. Note that the X directions indicated as the X1 direction and the X2 direction correspond to the radial directions of the stator core 20.

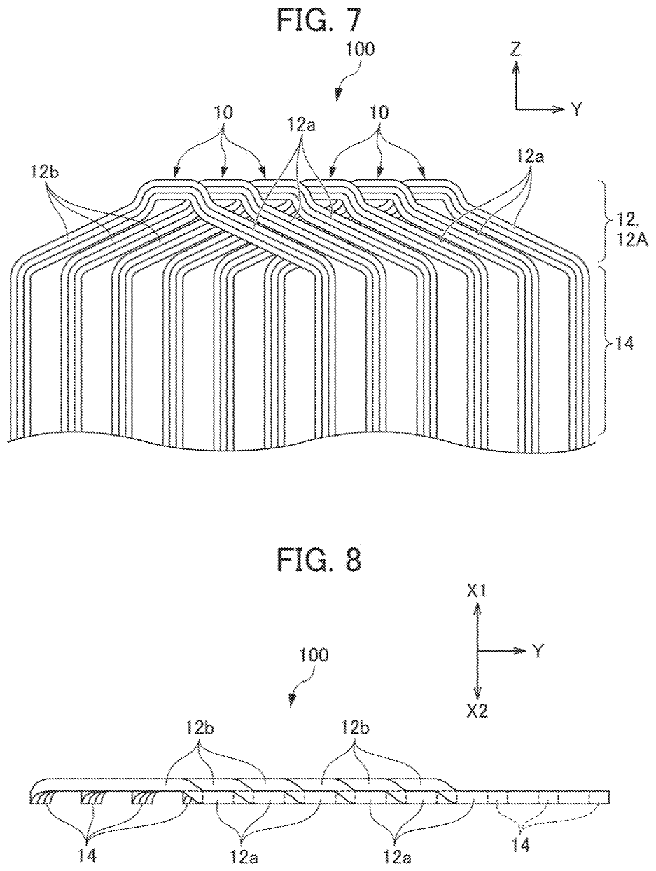

A plurality of coil wires 10 formed into a substantial U-shape are arranged in parallel to each other, as illustrated in FIGS. 7 and 8, to form the wave winding coil 1. The plurality of coil wires 10 are arranged in parallel to each other to form a group of conductors 100. In the present embodiment, six coil wires 10 belonging to three phases are used. The six coil wires 10 are arranged in parallel to each other while being offset by a predetermined pitch in the Y directions to thereby form the group of conductors 100. At this time, the twelve straight parts 14 are arranged in parallel to each other at equal intervals corresponding to slot intervals on the stator core 20. The first inclined part 12a and the second inclined part 12b of each first turning part 12A are offset by the wire width W of the coil wire 10 in the opposite directions along the X directions, and therefore, when the coil wires 10 and 10 adjacent to each other are stacked together such that the first inclined part 12a of one of the first turning parts 12A and 12A adjacent to each other and the second inclined part 12b of another one of the first turning parts 12A and 12A adjacent to each other intersect each other, all the twelve straight parts 14 are therefore disposed within a single plane extending in the Y directions.

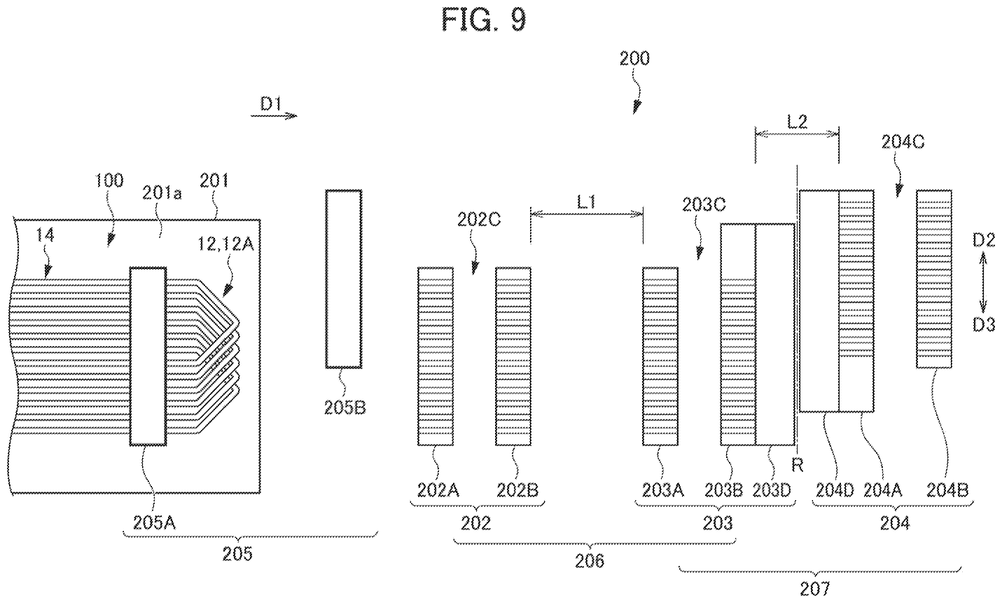

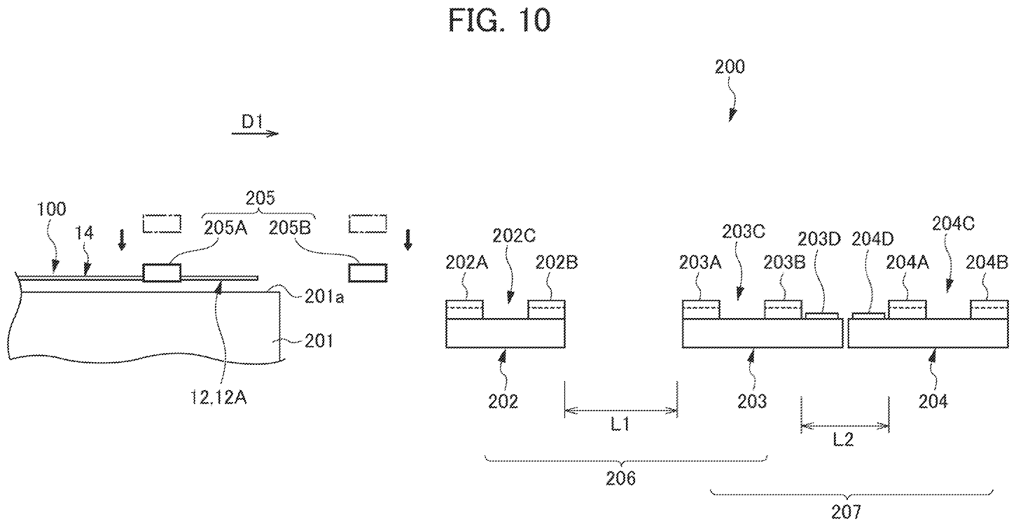

Next, a method of forming the wave winding coil 1 from the group of conductors 100 including the six coil wires 10 arranged in parallel to each other will be described. A specific configuration of a conductor forming device 200 for use to form the wave winding coil 1 will be first described with reference to FIGS. 9 and 10.

The conductor forming device 200 includes a loading stand 201 on which the group of conductors 100 is loaded, a first clamp part 202, a second clamp part 203, and a third clamp part 204 that hold the group of conductors 100 to form inclined parts and to perform folding, and a holder 205 that holds and conveys the group of conductors 100.

On an upper surface 201a of the loading stand 201, the group of conductors 100 conveyed by a conveyor (not shown) is laid such that the turning parts 12 (first turning parts 12A) face the first clamp part 202.

The first clamp part 202, the second clamp part 203, and the third clamp part 204 are disposed along a conveyance route for the group of conductors 100 to be formed, and are movable upward and downward in the top-bottom direction of the conductor forming device 200 (in vertical direction with respect to the page of FIG. 9, and in the top-bottom direction in FIG. 10). The first clamp part 202, the second clamp part 203, and the third clamp part 204 are configured to be positioned below the upper surface 201a of the loading stand 201 so as not to interrupt the conveyance of the group of conductors 100 when the first, second and third clamp parts 202, 203, and 204 are not clamping the group of conductors 100, and to move upward to hold the group of conductors 100 when the group of conductors 100 is conveyed to reach a position above the first, second, and third clamp parts 202, 203, and 204.

The first clamp part 202 is disposed most proximally to the loading stand 201. The first clamp part 202 includes a pair of clamping members 202A and 202B that collectively hold the straight parts 14 of the coil wires 10 included in the group of conductors 100. The clamping members 202A and 202B each have a width equal to or greater than the width of the group of conductors 100 in the Y directions illustrated in FIG. 7, and are disposed to face the conveyance route for the group of conductors 100 and arranged in parallel to each other at a certain interval in a D1 direction that is a conveyance direction of the group of conductors 100. The certain interval between the clamping members 202A and 202B defines a space 202C where a holding member 205A or 205B of the holder 205, which will be described later, can be accommodated.

The second clamp part 203 is disposed on a side distant from the loading stand 201, relative to the first clamp part 202. The second clamp part 203 includes a pair of clamping members 203A and 203B that collectively hold the straight parts 14 of the coil wires 10 included in the group of conductors 100, similarly to the first clamp part 202. The clamping members 203A and 203B also each have a width equal to or greater than the width of the group of conductors 100, and are disposed to face the conveyance route for the group of conductors 100 and arranged in parallel to each other at a certain interval in the D1 direction that is the conveyance direction of the group of conductors 100. The certain interval between the clamping members 203A and 203B defines a space 203C where the holding member 205A or 205B of the holder 205, which will be described later, can be accommodated.

The third clamp part 204 is disposed on a side further distant from the loading stand 201, relative to the second clamp part 203. The third clamp part 204 includes a pair of clamping members 204A and 204B that collectively hold the straight parts 14 of the coil wires 10 included in the group of conductors 100, similarly to the first clamp part 202 and the second clamp part 203. The clamping members 204A and 204B also each have a width equal to or greater than the width of the group of conductors 100, and are disposed to face the conveyance route for the group of conductors 100 and arranged in parallel to each other at a certain interval in the D1 direction that is the conveyance direction of the group of conductors 100. The certain interval between the clamping members 204A and 204B defines a space 204C where the holding member 205A or 205B of the holder 205, which will be described later, can be accommodated.

The second clamp part 203 and the third clamp part 204 are provided with pressing members 203D and 204D, respectively, which are movable upward and downward in the top-bottom direction. The pressing members 203D and 204D are each formed from a plate-like member for pressing, with its surface, the group of conductors 100. The pressing member 203D of the second clamp part 203 is provided on a side distant from the loading stand 201, and is disposed proximally to and in parallel to the clamping member 203B. The pressing member 204D of the third clamp part 204 is provided on a side proximal to the loading stand 201, and is disposed proximally to and in parallel to the clamping member 204A. FIG. 10 illustrates a state in which the pressing members 203D and 204D are at respective positions after being moved downward. At this time, upper surfaces of the pressing members 203D and 204D are disposed below upper surfaces of the clamping members 203A, 203B, 204A, and 204B so as not to interrupt the conveyance of the group of conductors 100 and a holding operation and a conveyance operation for the group of conductors 100 by each clamping member 203A, 203B, 204A, 204B.

As illustrated in FIGS. 9 and 10, the clamping member 202B, which belongs to the first clamp part 202 and is disposed on a side distant from the loading stand 201, is separated by a distance L1 from the clamping member 203A, which belongs to the second clamp part 203 and is disposed on a side proximal to the loading stand 201. The clamping member 203B, which belongs to the second clamp part 203 and is disposed on a side distal from the loading stand 201, is separated by a distance L2 from the clamping member 204A, which belongs to the third clamp part 204 and is disposed on a side proximal to the loading stand 201. The distance L2 is shorter than the distance L1.

The third clamp part 204 is disposed to be offset, with respect to the first clamp part 202 and the second clamp part 203, in one direction (a D2 direction in FIG. 9) of width directions of the conductor forming device 200 (D2-D3 directions in FIG. 9). The D2-D3 directions are directions orthogonal to the D1 direction that is the conveyance direction of the group of conductors 100. An amount of offset of the third clamp part 204 in the D2 direction with respect to the second clamp part 203 corresponds to one-half of the width of the group of conductors 100, i.e., a pitch for the six straight parts 14 of the coil wires 10.

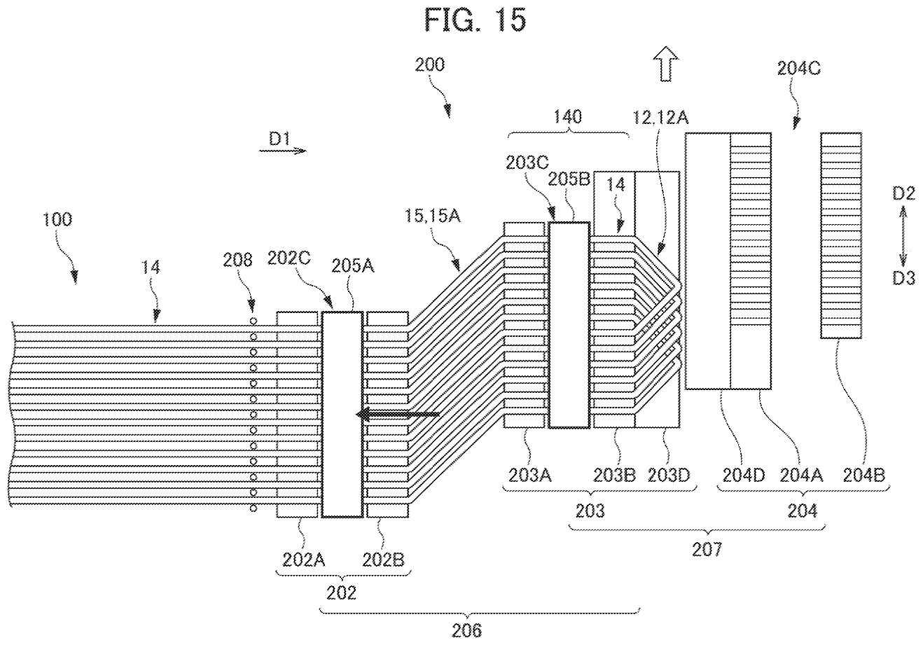

The second clamp part 203 and the third clamp part 204 are movable integrally with each other by means of a movement mechanism (nor shown) in the width directions of the conductor forming device 200. In contrast, the first clamp part 202 is immovable. Therefore, when the second clamp part 203 moves relative to the first clamp part 202 in one of the width directions of the conductor forming device 200 in a state in which at least the first clamp part 202 and the second clamp part 203 hold the group of conductors 100, the straight parts 14 of the group of conductors 100 disposed between the first clamp part 202 and the second clamp part 203 can be obliquely bent to form inclined parts 15 illustrated in FIG. 15. Accordingly, the first clamp part 202 and at least the second clamp part 203 constitute an inclined part forming mechanism 206 in the conductor forming device 200.

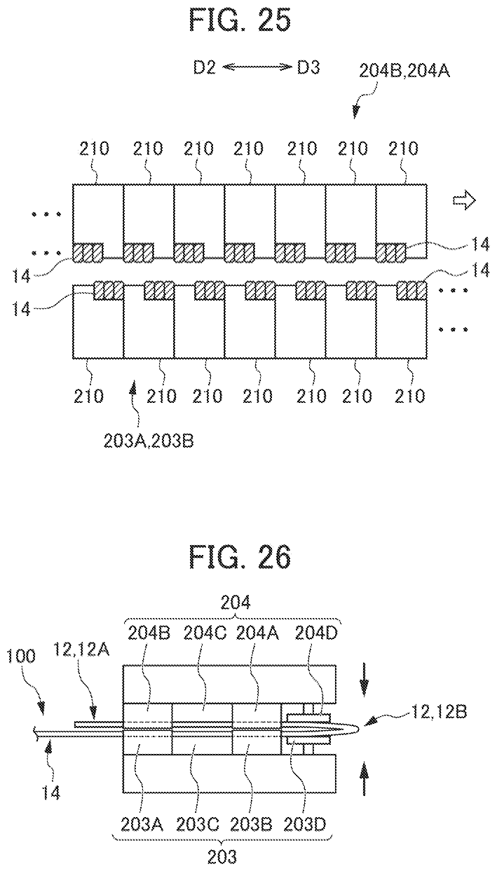

The third clamp part 204 is configured to rotationally move by means of a rotational movement mechanism (not shown). As illustrated in FIG. 25, the third clamp part 204 can be placed over the second clamp part 203 by way of folding along a folding line R (see FIG. 9) extending in the width directions between the second clamp part 203 and the third clamp part 204. With the rotation movement of the third clamp part 204, the clamping member 204B, the clamping member 204A, the space 204C, and the pressing member 204D are placed over the clamping member 203A, the clamping member 203B, the space 203C, and the pressing member 203D, respectively. Thus, the conductor 100 held by the second clamp part 203 and the third clamp part 204 is folded along the folding line R in thickness directions (the X1-X2 directions in FIG. 8). Accordingly, the second clamp part 203 and the third clamp part 204 constitute a folding mechanism 207 in the conductor forming device 200.

As illustrated in FIG. 10, the holder 205 is disposed above the upper surface 201a of the loading stand 201, and is configured to move upward and downward with respect to the group of conductors 100 disposed below the holder 205, by means of an ascend/descend mechanism (not shown). The holder 205 includes the pair of holding members 205A and 205B each having a width equal to or greater than the width of the group of conductors 100. The pair of holding members 205A and 205B have the same structure. The holding members 205A and 205B are disposed to be separated from each other by a certain distance in the D1 direction, and the holding member 205B is disposed to be offset with respect to the holding member 205A in the D2 direction.

The holder 205 according to the present embodiment is provided separately from the second clamp part 203 and the third clamp part 204 constituting the folding mechanism 207. This configuration makes it possible to constantly maintain a folding position in the folding mechanism 207 unchanged, which enables a suitable positional accuracy to be achieved for the folding position.

The holder 205 is movable relative to the first clamp part 202, the second clamp part 203, and the third clamp part 204 in the D1 direction. In the present embodiment, the holder 205 is movable in the D1 direction. Therefore, the holder 205 conveys the group of conductors 100 held thereon, along the conveyance route in the D1 direction, and changes a relative position with respect to the first clamp part 202, the second clamp part 203, and the third clamp part 204.

In an initial state illustrated in FIG. 9, the interval between the pair of holding members 205A and 205B in the D1 direction is slightly narrower than the interval between the space 202C of the first clamp part 202 and the space 203C of the second clamp part 203, and is equal to the interval between the space 203C of the second clamp part 203 and the space 204C of the third clamp part 204. An amount of offset of the holding member 205B with respect to the holding member 205A in the D2 direction is equal to the amount of offset of the third clamp part 204 with respect to the second clamp part 203 in the D2 direction.

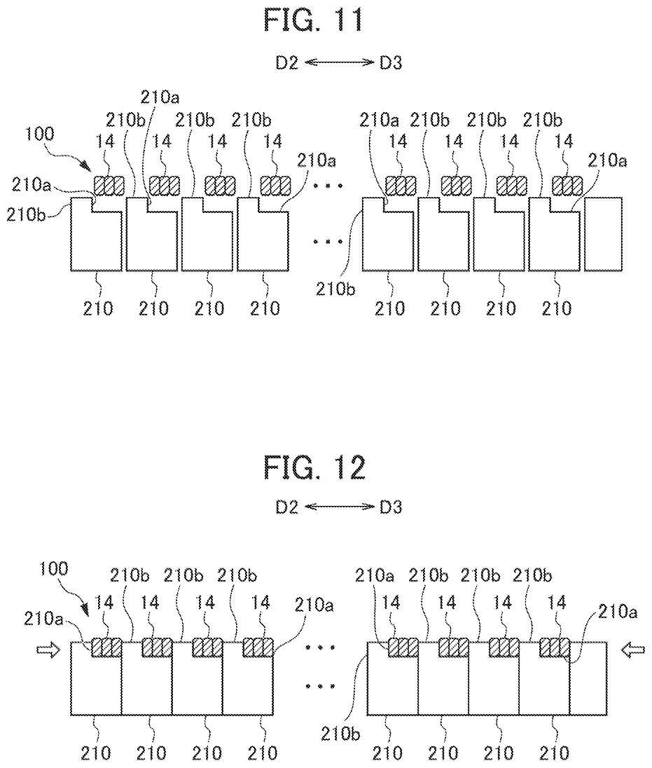

Specific structures, for holding the group of conductors 100, of the clamping members 202A, 202B, 203A, 203B, 204A, and 204B and the holding members 205A and 205B may be identical to each other, among the clamping members 202A, 202B, 203A, 203B, 204A, and 204B and the holding members 205A and 205B. As illustrated in FIGS. 11 and 12, a structure for holding the group of conductors 100 can be configured with, for example, a plurality of blocks 210 arranged in parallel to each other in an openable and closable manner in width directions (the Y directions in FIG. 7) of the group of conductors 100. The blocks 210 each have a groove 210a having a width slightly narrower than a width of the straight part 14 of each of the coil wires 10 constituting the group of conductors 100 (a width in the Y direction in FIG. 4). The grooves 210a extend in the D1 direction that the extending directions of the straight parts 14 of the group of conductors 100.

Each groove 210a is formed by cutting out a portion from the block 210, from one side surface of the in its width directions to a substantial half of an upper surface of the block 210, and a remaining half of the upper surface of the block 210 forms a pinching piece 210b that pinches one of the straight parts 14 of the coil wires 10. One groove 210a and one pinching piece 210b are formed on each block 210. The grooves 210a and the pinching pieces 210b are greater in number than the straight parts 14 of the group of conductors 100. Specifically, in the present embodiment, one clamping member 202A, 202B, 203A, 203B, 204A, 204B or one holding member 205A, 205B has at least the twelve grooves 210a and at least the twelve pinching pieces 210b.

As illustrated in FIG. 11, when the blocks 210 move away from each other, each of the clamping members 202A, 202B, 203A, 203B, 204A, and 204B and the holding members 205A and 205B is brought into an open state. At this time, the width of the groove 210a between the pinching pieces 210b and 210b adjacent to each other becomes wider than the width of the straight part 14 of the coil wire 10. Therefore, the straight part 14 of the coil wires 10 can be accommodated in or removed from the groove 210a.

On the other hand, as illustrated in FIG. 12, when the blocks 210 are in full contact with each other, each of the clamping members 202A, 2028, 203A, 2038, 204A, and 204B and the holding members 205A and 2058 is brought into a closed state. At this time, the width of the groove 210a between the pinching pieces 210b and 210b adjacent to each other becomes slightly narrower than the width of the straight part 14 of the coil wire 10. Therefore, the straight parts 14 of the coil wires 10, which are accommodated in the respective grooves 210a, are each individually pinched between the pinching pieces 210b and 210b adjacent to each other. Thus, the group of conductors 100 is held.

In this way, each of the clamping members 202A, 202B, 203A, 203B, 204A, and 204B and the holding members 205A and 205B for holding the group of conductors 100 holds the straight parts 14 of the coil wires 10 in the width directions. The width directions of the straight parts 14 (the Y directions illustrated in FIGS. 4 and 7) correspond to a stacking direction of the plurality of unit wires 10a included in each coil wire 10. Therefore, even when there is variation in the thickness direction (the X directions illustrated in FIG. 4) between the plurality of unit wires 10a, it is possible to integrally pinch and hold the plurality of unit wires 10a included in each of the coil wires 10. In addition, no separate pressing member is required for pressing the coil wires 10 to prevent the unit wires 10a from becoming loose, making it possible to reduce the size of the device.

Note that, FIGS. 11 and 12 illustrate a case where the straight parts 14 of the group of conductors 100 are held from below. The case corresponds to a case where the clamping members 202A, 202B, 203A, 203B, 204A, and 204B hold the straight parts 14 of the group of conductors 100 from below. A case where the holding members 205A and 205B hold the straight parts 14 of the group of conductors 100 from above corresponds to a configuration resulting from vertical reversal of the configuration illustrated in FIGS. 11 and 12.

Next, a specific forming operation when the conductor forming device 200 performs forming on the group of conductors 100 will be described. As illustrated in FIGS. 9 and 10, the group of conductors 100 including the six coil wires 10 is first loaded on the upper surface 201a of the loading stand 201 with the turning parts 12 (the first turning parts 12A) facing toward the first clamp part 202.

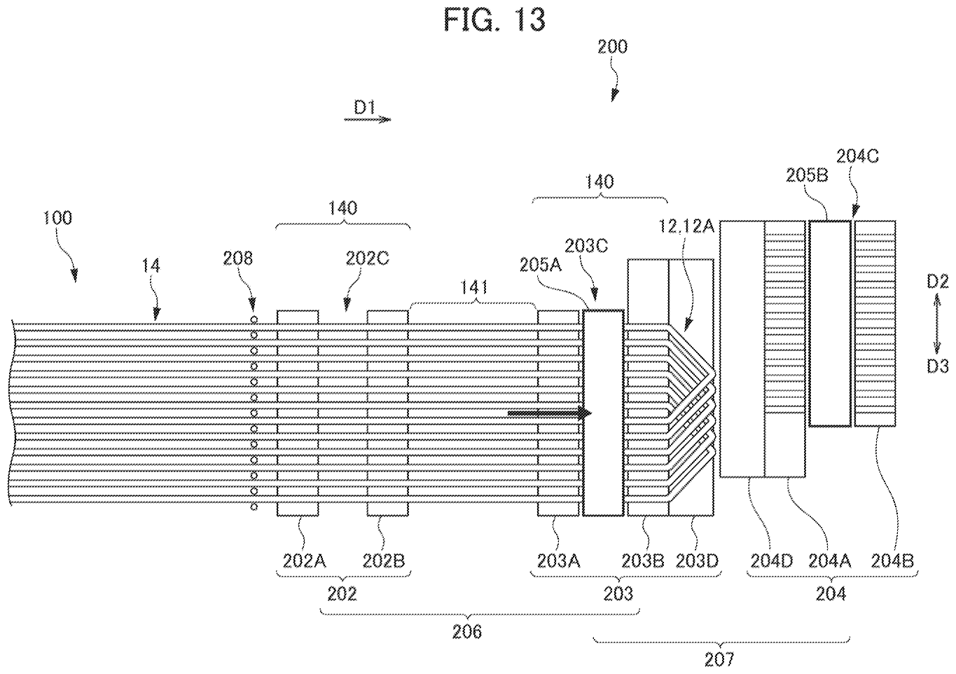

When the holder 205 moves toward the group of conductors 100 on the loading stand 201, and the holding member 205A on the side proximal to the loading stand 201 reaches a position above the group of conductors 100, the holder 205 moves downward and the holding member 205A holds each of the straight parts 14 that lie in proximity to the turning parts 12 (the first turning parts 12A) of the group of conductors 100. At this time, the other holding member 205B stays between the loading stand 201 and the first clamp part 202, and does not hold the group of conductors 100. The holder 205 having the group of conductors 100 held hereon linearly moves in the D1 direction along the extending direction of the straight parts 14 to thereby convey, as illustrated in FIG. 13, the group of conductors 100 to a position above the first clamp part 202 and the second clamp part 203 constituting the inclined part forming mechanism 206.

Reference numeral 208 in FIG. 13 indicates guide members that are a plurality of pins disposed between the loading stand 201 and the first clamp part 202. After the turning parts 12 (the first turning parts 12A) of the group of conductors 100 have passed above the first clamp part 202, the guide members 208 move upward from below the group of conductors 100, and each enter a space between the straight parts 14 and 14 adjacent to each other. Consequently, the straight parts 14 of the group of conductors 100 being conveyed are prevented from interfering with each other, and the group of conductors 100 being conveyed are thus smoothly guided.

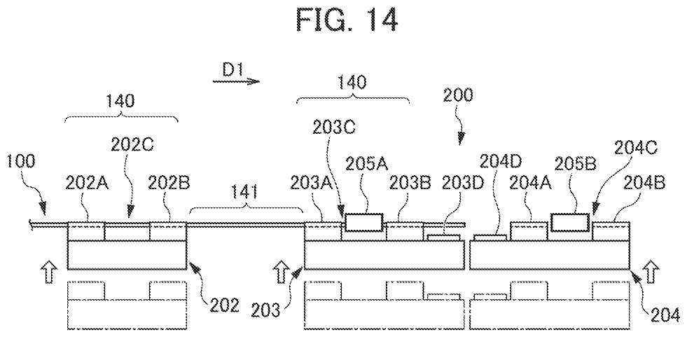

As illustrated in FIGS. 13 and 14, after the holding member 205A holding the group of conductors 100 moves to a position above the space 203C of the second clamp part 203, the first clamp part 202, the second clamp part 203, and the third clamp part 204 integrally move upward, whereby the holding member 205A is accommodated in the space 203C. When the first clamp part 202 and the second clamp part 203 move upward, the clamping members 202A, 202B, 203A, and 203B are in an open state, as illustrated in FIG. 11. Therefore, as the first clamp part 202 and the second clamp part 203 move upward, the straight parts 14 of the group of conductors 100 are accommodated in respective grooves 210a each of which is between pinching pieces 210b and 201b adjacent to each other. After the straight parts 14 are accommodated in the grooves 210a, the clamping members 202A, 202B, 203A, and 203B are closed, and hold the group of conductors 100.

As illustrated in FIGS. 13 and 14, holding target parts 140 and 140 of the straight parts 14 that the first clamp part 202 and the second clamp part 203 hold, respectively, are portions corresponding to the in-slot disposition parts 11 of the wave winding coil 1. Therefore, the interval between the pair of clamping members 202A and 202B in the extending direction of the straight parts 14 (a length in the D1 direction of the first clamp part 202 including the space 202C) and the interval between the pair of clamping members 203A and 203B (a length in the D1 direction of the second clamp 203 including the space 203C) are each substantially equal to a length of each of the in-slot disposition parts 11 of the wave winding coil 1.

As illustrated in FIGS. 13 and 14, on the straight parts 14 of the group of conductors 100, portions 141 disposed between the first clamp part 202 and the second clamp part 203 are portions of the group of conductors 100 in which the inclined parts 15 are to be formed, and are also portions corresponding to the turning parts 12 of the wave winding coil 1. A length of each of the portions 141, i.e., the distance L1 between the first clamp part 202 and the second clamp part 203 illustrated in FIGS. 9 and 10, is substantially equal to a length of each of the turning parts 12 of the wave winding coil 1 when the turning part 12 is stretched straightforwardly.

After the first clamp part 202 and the second clamp part 203 hold the group of conductors 100, the holder 205 releases the holding of the group of conductors 100 and moves back upwardly to a position above the group of conductors 100. After that, for the preparation for a next holding operation, as illustrated in FIG. 15, the holding member 205A moves to a position above the space 202C of the first clamp part 202.

Next, the conductor forming device 200 causes, from a state where the first clamp part 202 and the second clamp part 203 are holding the group of conductors 100, the second clamp part 203 and the third clamp part 204 to move relative to the first clamp part 202 in the D2 direction, as illustrated in FIG. 15. Specifically, the first turning parts 12A of the coil wires 10 in the group of conductors 100 and the holding target parts 140 held by the second clamp part 203 are caused, within a plane on which the coil wires 10 included in the group of conductors 100 extend (within a plane of the page of FIG. 15), to be offset in the direction (the D2 direction) intersecting the extending directions of the straight parts 14. Consequently, the portions 141 including the twelve straight parts 14 disposed between the first clamp part 202 and the second clamp part 203 are inclined in the offset direction (the D2 direction), thereby forming respective first inclined parts 15 (inclined parts 15A) on the coil wires 10 included in the group of conductors 100.

An inclination angle of each of the inclined parts 15 relative to the straight parts 14 is, as illustrated in FIG. 5, substantially equal to the inclination angle of each of the first inclined parts 12a or the second inclined parts 12b of the turning parts 12 formed on the coil wires 10. Forming the inclined parts 15 on the group of conductors 100 causes a side adjacent to the turning parts 12 (the first turning parts 12A) of the group of conductors 100 held by the second clamp part 203 to be disposed and offset, with respect to the straight parts 14 held by the first clamp part 202, in the D2 direction by an amount of offset corresponding to one-half of the width of the group of conductors 100, i.e., a pitch for the six straight parts 14 of the coil wires 10.

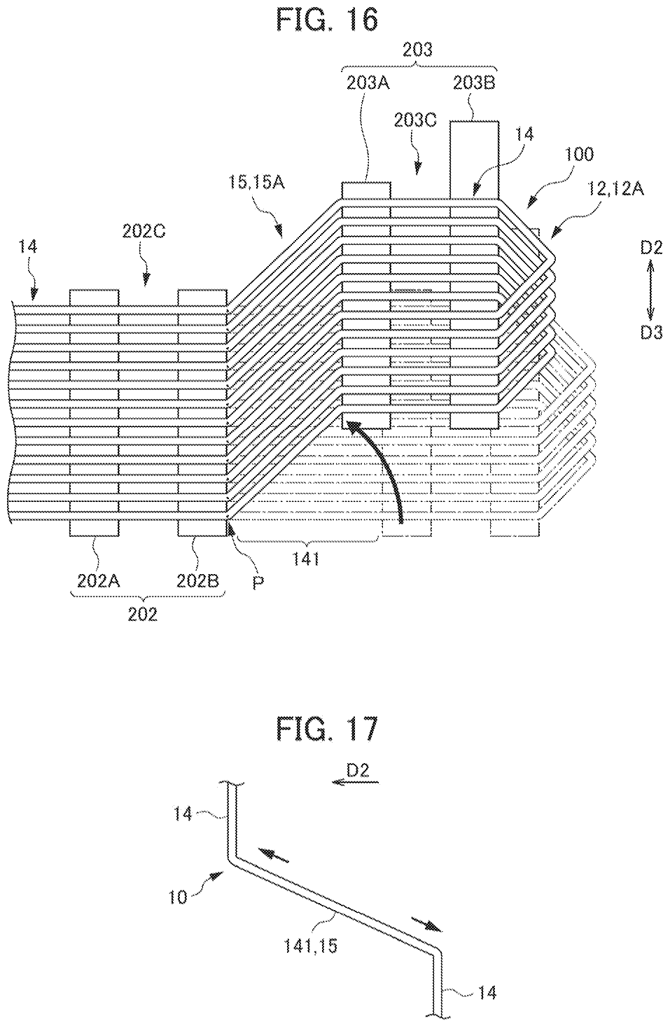

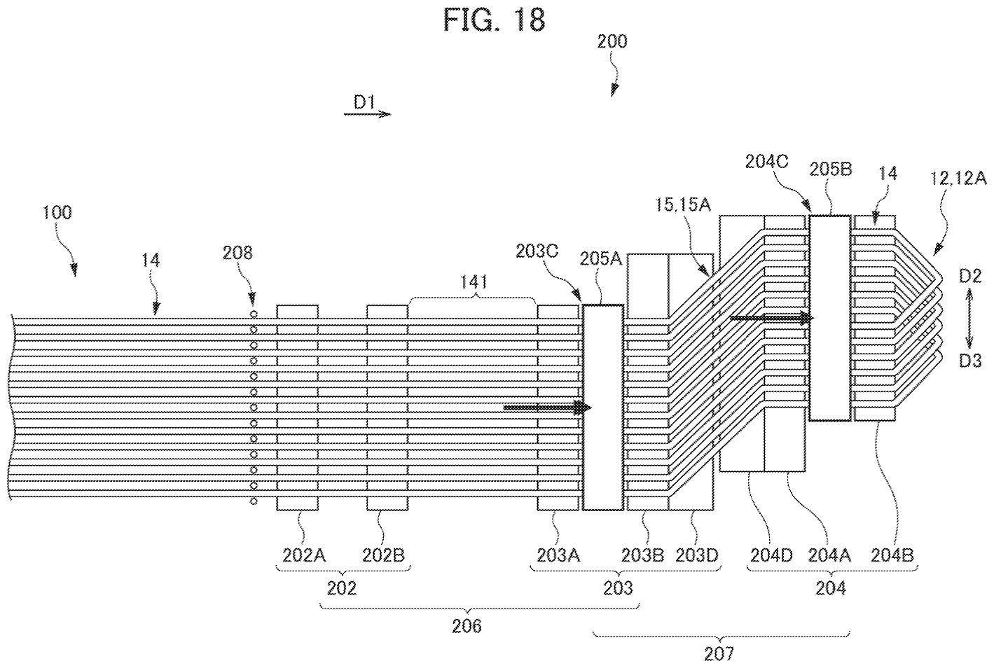

The conductor forming device 200 according to the present embodiment is configured to not cause, when the inclined parts 15 are to be formed, the side adjacent to the second clamp part 203 to move straightforwardly in the D2 direction, but, as illustrated in FIG. 16, to cause the side adjacent to the second clamp part 203 to move in an arc shape centered on bending points P serving as boundary points between the inclined parts 15 and the straight parts 14 that are continuous from the inclined parts 15 and are held by the first clamp part 202, at a radius corresponding to a length of each of the inclined parts 15. At this time, the side adjacent to the second clamp part 203 keeps the parallelism to the first clamp part 202, and moves in the arc shape. Consequently, as illustrated in FIG. 17, the inclined part 15 (the portion 141) is pulled in opposite directions and formed, whereby the straightness of the inclined part 15 after being formed becomes satisfactory, thereby improving the forming accuracy for the inclined part 15.

When the second clamp part 203 is offset in the D2 direction to form the inclined parts 15, as illustrated in FIG. 15, the interval between the space 202C of the first clamp part 202 and the space 203C of the second clamp part 203 becomes slightly smaller, and becomes coincident with the interval between the pair of holding members 205A and 205B. Therefore, after formation of the first inclined parts 15 (the inclined parts 15A) of the group of conductors 100, when the holder 205 lying at the position illustrated in FIG. 15 moves downward toward the group of conductors 100, the holding members 205A and 205B are accommodated in the spaces 202C and 203C, respectively, which makes it possible to hold the group of conductors 100.

At this time, since the pair of holding members 205A and 205B hold the group of conductors 100 at two points on the straight parts 14 and 14 disposed on both sides with respect to the inclined parts 15, respectively, the group of conductors 100 is less likely to become loose. Thereafter, as the holder 205 holds the group of conductors 100, the first clamp part 202 and the second clamp part 203 release the holding of the group of conductors 100, move downward and also move in the D3 direction, and return to the positions in the initial state.

Thereafter, the holder 205 holding the group of conductors 100 moves in the D1 direction to convey the group of conductors 100, as illustrated in FIG. 18, until the holding member 205A reaches a position above the space 203C of the second clamp part 203, and the holding member 205B reaches a position above the space 204C of the third clamp part 204. The third clamp part 204 is offset beforehand in the D2 direction with respect to the first clamp part 202 and the second clamp part 203 by one-half of the width of the group of conductors 100, and the holding member 205B of the holder 205 is similarly offset with respect to the holding member 205A. Therefore, as the first clamp part 202, the second clamp part 203, and the third clamp part 204 move upward, the holding members 205A and 205B holding the group of conductors 100 having the first inclined parts 15 (the inclined parts 15A) are formed thereon are accommodated in the space 203C of the second clamp part 203 and the space 204C of the third clamp part 204, respectively.

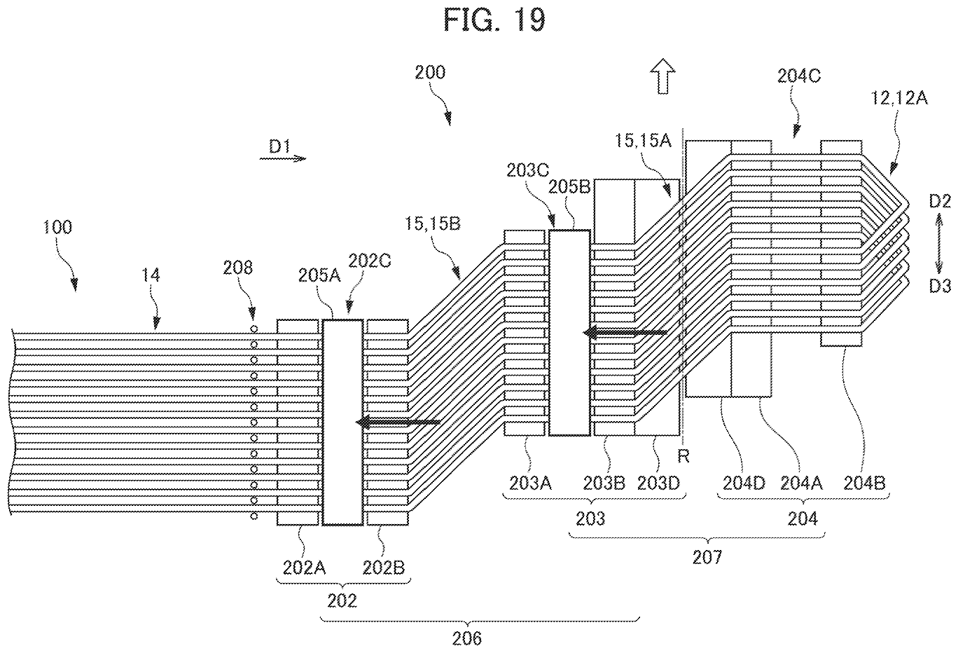

After moving upward, the first clamp part 202, the second clamp part 203, and the third clamp part 204 hold the straight parts 14 of the group of conductors 100, and then the holder 205 releases the holding of the group of conductors 100. At this time, the inclined parts 15 formed on the group of conductors 100 are disposed between the clamping member 203B of the second clamp part 203 and the clamping member 204A of the third clamp part 204. That is, the distance L2 between the clamping member 203B and the clamping member 204A is substantially equal to a distance between the straight parts 14 and 14 that are adjacent to each other with the inclined parts 15 interposed therebetween. The portions 141 to be then newly formed as the inclined parts 15 are also disposed between the first clamp part 202 and the second clamp part 203. After retracting upward to a position above the group of conductors 100, the holder 205 moves, for the preparation of next holding, as illustrated in FIG. 19, to the position above the space 202D of the first clamp part 202 and the space 203C of the second clamp part 203.

Thereafter, similar to the case illustrated in FIG. 15, the second clamp part 203 and the third clamp part 204 are caused to move in the D2 direction to form, as illustrated in FIG. 19, each of second inclined parts 15 (the inclined parts 15B) between the first clamp part 202 and the second clamp part 203 (inclined part forming step).

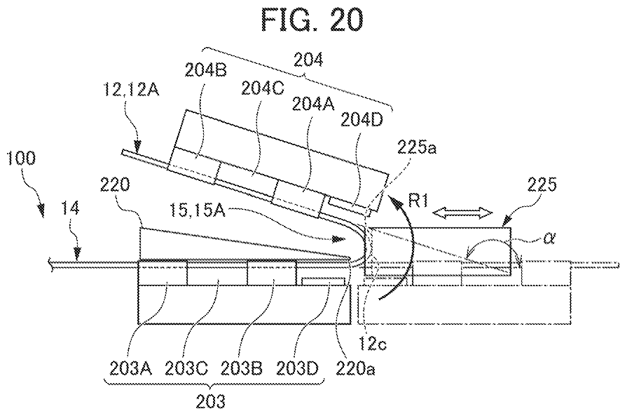

Next, at the center portion of each of the first inclined parts 15A disposed between the second clamp part 203 and the third clamp part 204, i.e., at points along the folding line R disposed between the second clamp part 203 and the third clamp part 204 (see FIGS. 9 and 19), the third clamp part 204 performs a rotation movement to be placed over the second clamp part 203, as illustrated in FIG. 20, to fold the first inclined parts 15A (folding step).

With the rotation movement of the third clamp part 204, the first inclined parts 15A of the group of conductors 100 are folded in one of the thickness directions of the group of conductors 100. The folding line R extends in the D2-D3 directions along the width directions of the group of conductors 100, and intersects with the inclined parts 15A. Therefore, as the inclined parts 15A are folded, the folded parts newly serve as the twelve turning parts 12 (second turning parts 12B) each having a V or inverted V shape (a triangular shape) having the apex parts (the apex parts 12c) at the folding line R. In the present embodiment, the rotation movement of the third clamp part 204 causes the inclined parts 15A to be folded forward along the folding line R in a direction toward the near side on the plane of the page of FIG. 19 (an R1 direction).

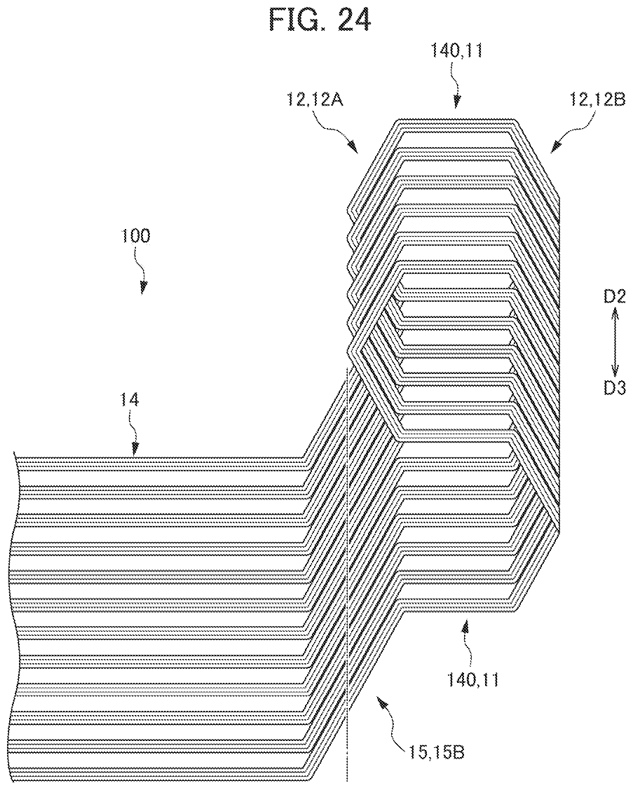

FIG. 24 illustrates only the group of conductors 100 after the first inclined parts 15A are folded. As illustrated in FIG. 24, after the first inclined parts 15A are folded, the holding target parts 140 and 140 of the straight parts 14 held by the second clamp part 203 and the third clamp part 204 partially overlap with each other to be parallel to each other. Specifically, six out of the twelve holding target parts 140 held by the second clamp part 203 and six out of the twelve holding target parts 140 held by the third clamp part 204 overlap with each other. Consequently, the in-slot disposition parts 11, a total width of which corresponds to a total width of the 18 straight parts 14, are formed.

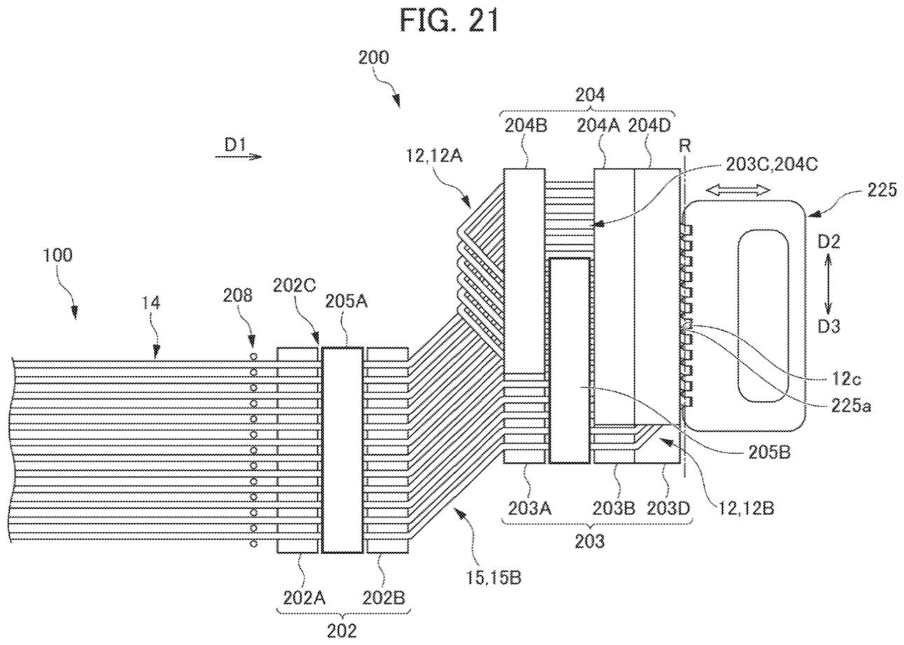

Note that, in the present embodiment, before the folding step is performed for the first time on the group of conductors 100, the two inclined parts 15 (the inclined parts 15A and 15B) are formed. Therefore, as illustrated in FIG. 21, the turning parts 12 (the first turning parts 12A) of the group of conductors 100 after folding are disposed to overlap with the secondly formed inclined parts 15 (the inclined parts 15B). Therefore, the turning parts 12 after folding do not interfere with the straight parts 14 of the group of conductors 100.

As illustrated in FIG. 20, when the inclined parts 15 are to be folded, a folding jig 220 may be inserted between the second clamp part 203 and the third clamp part 204. The folding jig 220 has a triangular shape in cross section, and a peripheral part 220a having an acute apex is inserted along the folding line R on the inclined parts 15. This enables the third clamp part 204 to accurately fold the inclined parts 15 along the folding line R. Before the folding operation is completed, the folding jig 220 is removed from between the second clamp part 203 and the third clamp part 204.

As illustrated in FIGS. 20 and 21, when the inclined parts 15 are to be folded, a restrainer 225 that restrains the apex parts 12c of the turning parts 12 may be disposed at the apex parts 12c (the first turning parts 12A) of the turning parts 12 in the midst of folding.

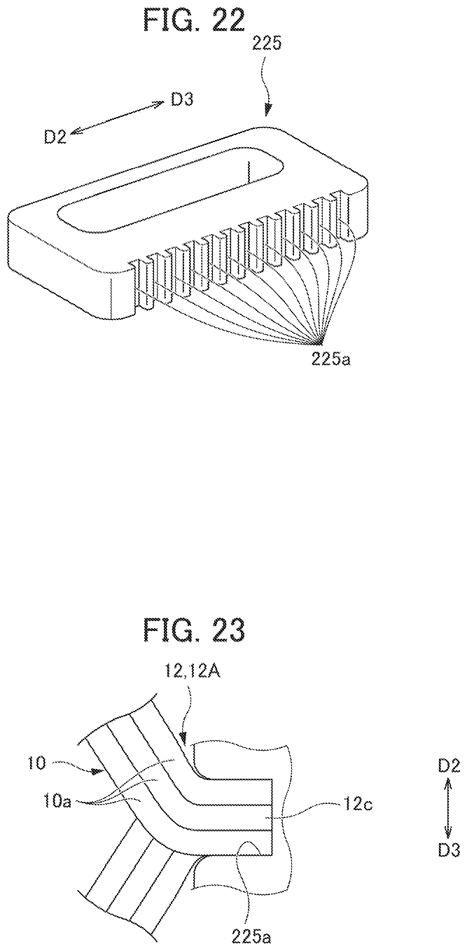

The restrainer 225 has a rectangular parallelepiped shape, as illustrated in FIG. 22. The restrainer 225 has a predetermined length in the D1 direction as illustrated in FIG. 21, and extends longer in the D2-D3 directions than a range in which the plurality of turning parts 12 of the group of conductors 100 are arranged in the D2-D3 directions and has a predetermined height in the top-bottom direction as illustrated in FIG. 20.

As illustrated in FIGS. 21 and 22, the restrainer 225 has a plurality of grooves 225a that are arranged side by side in the D2-D3 directions to face the apexes of the turning parts 12 (the first turning parts 12A) of the group of conductors 100. The plurality of groove 225a are arranged in parallel to each other in the D2-D3 directions at predetermined intervals, in correspondence with the plurality of coil wires 10 arranged to be formed at the same time.

The plurality of grooves 225a are formed to be recessed in a U shape in cross section from a surface of the restrainer 225 adjacent to the turning parts 12 (the first turning parts 12A) of the group of conductors 100, and extend in the top-to-bottom direction.

As illustrated in FIG. 23, when the coil wires 10 each consisting of at least two unit wires 10a are to be folded, the apex part 12c of the turning part 12 (the first turning part 12A) of the coil wire 10 consisting of at least two unit wires 10a is fitted in each of the plurality of grooves 225a, and the groove 225a limits the width of the coil wire 10 in the D2-D3 directions to a predetermined distance.

In the folding step, in a state where the width in the D2-D3 directions of each of the apex parts 12c of the turning parts 12 (the first turning parts 12A) each consisting of at least two unit wires 10a is limited to the predetermined distance by the restrainer 225, the two or more unit wires 10a are folded at the same time to form the turning part 12 (the first turning part 12A). In the folding step, the apex parts 12c of the plurality of turning parts 12 (the first turning parts 12A) arranged to be formed at the same time are fitted into the plurality of grooves 225a of the restrainer 225, whereby the plurality of turning parts 12 (the first turning parts 12A) arranged to be formed at the same time are arranged in parallel to each other in the D2-D3 directions at the predetermined intervals.

FIG. 20 illustrates a timing at which the restrainer 225 is attached. After the plurality of turning parts 12 (the first turning parts 12A) are folded at a folding angle α (for example, an angle α=150°), the restrainer 225 is moved from a side away from the turning parts 12 (the first turning parts 12A) toward the turning parts 12 (the first turning parts 12A) to thereby be attached to the plurality of turning parts 12 (the first turning parts 12A). Thereafter, in a state where the restrainer 225 is attached, the plurality of turning parts 12 (the first turning parts 12A) are further folded at an increased folding angle of 180°, and then the restrainer 225 is moved away from the turning parts 12 (the first turning parts 12A) so as to be detached. Attachment and detachment of the restrainer 225 may be performed by an automatic operation of an automatic machine or a human operation.

As described above, the restrainer 225 provided with the plurality of grooves 225a is disposed to the apex parts 12c of the turning parts 12 (the first turning parts 12A) in the midst of folding, which makes it possible to prevent twists from occurring near the apex parts 12c after bending the coil wires 10 arranged in parallel to each other, and to form the wave winding coil 1 in a uniform state. This makes it possible to improve the quality, and improve the workability of operations until the completion of fitting of the wave winding coil 1 into the slots 23 of the stator core 20 (e.g., straight conveyance, turning conveyance, attachment of jig, and fitting into the slots 23 of the stator core 20).

As illustrated in FIG. 25, after completion of folding of the inclined parts 15, the third clamp part 204 may also be caused to slightly move, in a state where the group of conductors 100 are held, relative to the second clamp part 203 in arrangement directions of the straight parts 14 and in width directions of the folded parts (the D2-D3 directions). This makes it possible to suppress occurrence of springback that is a phenomenon in which the turning parts 12 after the inclined parts 15 are folded open while returning to the original shape. It is also possible to adjust a pitch between adjacent ones of the six straight parts 14 that has been folded.

In the folding step, after the inclined parts 15 are folded, and in a state where the second clamp part 203 and the third clamp part 204 overlap with each other, as illustrated in FIG. 26, the pressing member 203D of the second clamp part 203 moves upward relative to the second clamp part 203, and the pressing member 204D of the third clamp part 204 also moves upward relative to the third clamp part 204, and the turning parts 12 that are the folded parts of the group of conductors 100 are thus pinched between the pressing members 203D and 204D and pressed in the thickness directions. This makes it possible to suppress expansion of the turning parts 12 in the thickness directions due to the springback and to further improve the forming accuracy for the turning parts 12. It is also possible to immediately press the turning parts 12 that have been formed by the second clamp part 203 and the third clamp part 204, thereby simplifying the device and the process steps, without the necessity of providing a separate station for pressing.

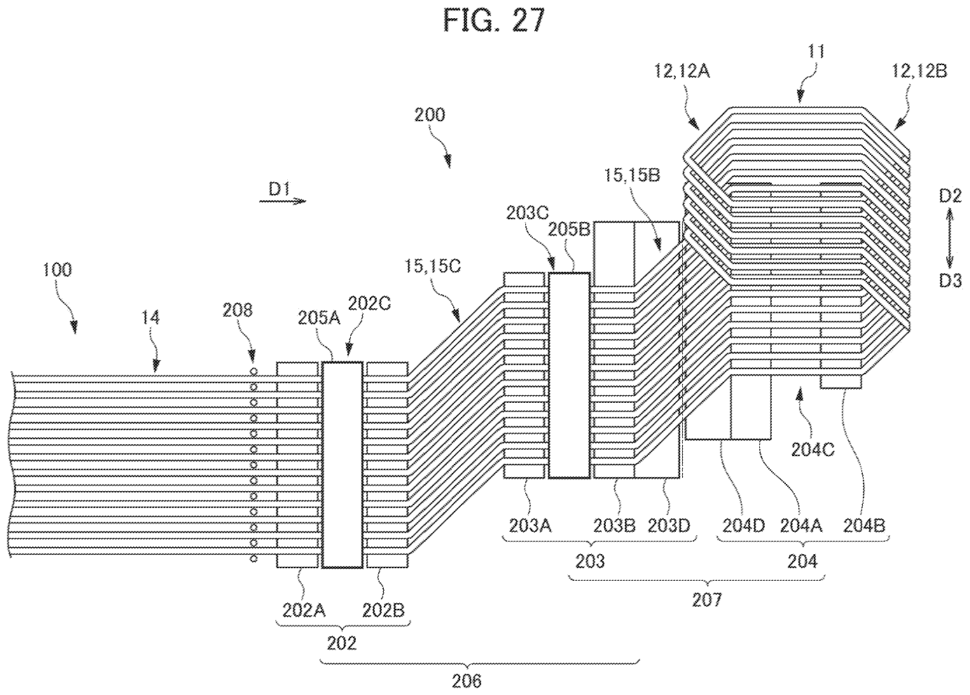

After the second turning parts 12B are formed, the holder 205 further conveys the group of conductors 100 in the D1 direction to dispose the secondly formed inclined parts 15B between the second clamp part 203 and the third clamp part 204. Thereafter, similar to the case illustrated in FIG. 19, third inclined parts 15 (inclined parts 15C) are formed on the straight parts 14 disposed between the first clamp part 202 and the second clamp part 203, as illustrated in FIG. 27.

Subsequent to the foregoing process, the folding step for the second inclined parts 15B, the inclined part forming step for forming the fourth inclined parts, the folding step for the third inclined parts 15C, and subsequent necessary steps are alternately and repeatedly executed in the same manner as described above until the wave winding coil 1 formed from the group of conductors 100 has a predetermined length corresponding to four turns around the stator core 20. Thus, the wave winding coil 1, which has a sheet shape forming eight layers (eight turns) and in which the in-slot disposition parts 11 are offset by an amount corresponding to six in-slot disposition parts 11 between two adjoining layers, is formed. Thus, in the wave winding coil 1 formed by the conductor forming device 200, where forming of the inclined parts 15 and folding of the inclined parts 15 are alternately repeated, formation errors that may occur when the coil wires 10 are folded are not accumulated in the inclined parts 15. Therefore, the in-slot disposition parts 11 and the turning parts 12 are formed with satisfactory forming accuracy.

When the coil wires 10 are formed from the plurality of unit wires 10a arranged in the thickness directions (the Y directions) as described in the present embodiment, it is inevitable that, when the inclined parts 15 are folded, a perimeter difference occurs among the unit wires 10a due to an angular difference between the extending directions and the folding direction of the inclined parts 15 before folding. In a case where all the inclined parts are formed beforehand as in the known art, there is a disadvantage that a perimeter difference that occurs at the time of the folding among the unit wires 10a affects the already formed inclined parts, causing shoulder bending parts of the formed inclined parts (starting points at which the inclined parts are bent) to be displaced. In contrast, alternately performing the inclined part forming step and the folding step as described in the present embodiment makes it possible to substantially cancel out, by way of forming of the next inclined parts 15, the adverse effects of a perimeter difference among the unit wires 10a caused by the folding. Therefore, even though the coil wires 10 are each formed from the plurality of unit wires 10a arranged in the thickness directions, it is possible to manufacture the wave winding coil 1 with improved forming accuracy.

Note that, the sheet-shaped wave winding coil 1 produced as described above has a two-layer structure where the in-slot disposition parts 11 overlap with each other, and further has, as illustrated in FIG. 1, the layer switching parts Ta at which the layers (turns) switch in the radial directions of the stator core 20, every length corresponding to one turn around the stator core 20. In the case of forming the wave winding coil 1 having this structure, in order to prevent layers from interfering with each other in the layer switching parts Ta, the folding step may include folding the inclined parts 15 corresponding to the layer switching parts Ta in a direction (an R2 direction) opposite to the previous folding direction (the R1 direction), as will be described below.

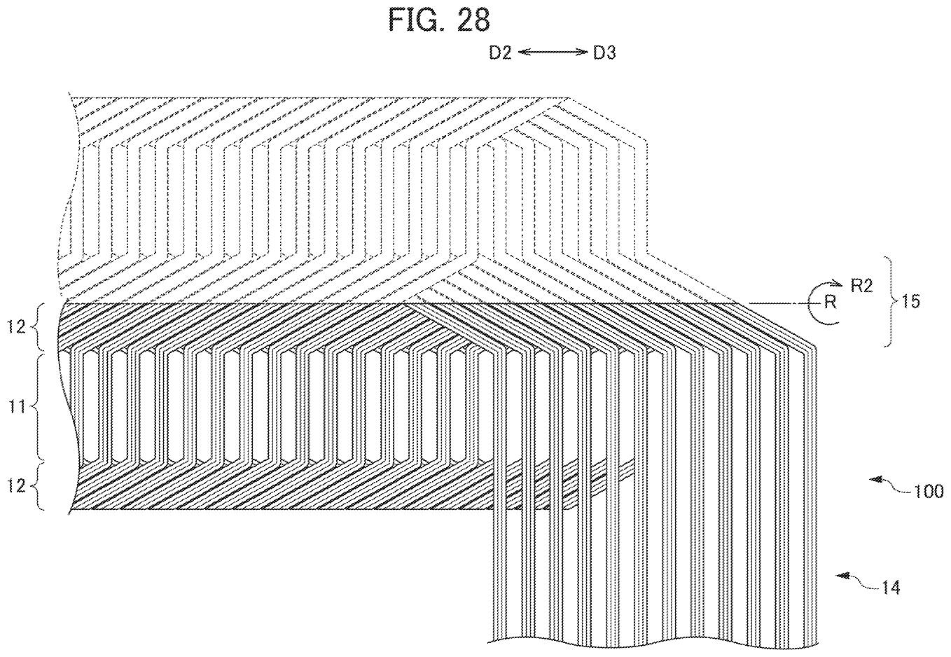

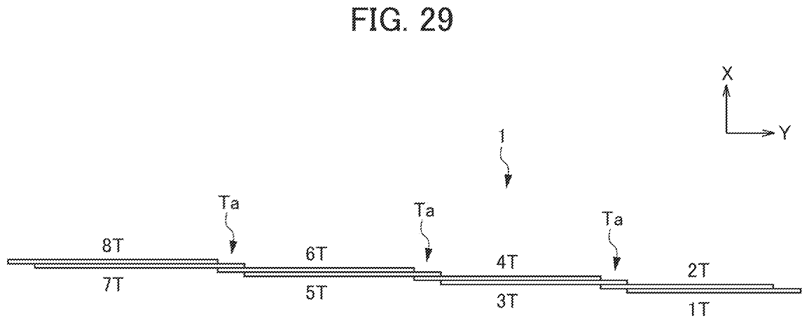

As illustrated in FIG. 28, in the folding step where the inclined parts 15 corresponding to the layer switching parts Ta are folded along the folding line R, the inclined parts 15 are folded back in the opposite direction (the R2 direction) that is opposite to the folding direction (the R1 direction) of the inclined parts 15 in the previous folding step. Specifically, in the case of the wave winding coil. 1 according to the present embodiment, as illustrated in FIG. 1, the layer switching parts Ta are present at three locations in total, i.e., between the seventh layer (7T) and the sixth layer (6T), between the fifth layer (5T) and the fourth layer (4T), and between the third layer (3T) and the second layer (2T). Accordingly, the inclined parts 15 are folded back in the opposite direction only in the folding step for the inclined parts 15 corresponding to the layer switching parts Ta, as described above. As a result, as illustrated in FIG. 29, in the layer switching parts Ta, an offset direction along one of the thickness directions of the turning parts 12 (the radial directions of the stator core 20, and the X directions in FIG. 29) is reversed, making it possible to prevent the layers from interfering with each other in the layer switching parts Ta when the wave winding coil 1 is attached to the stator core 20.

The sheet-shaped wave winding coil 1 described above does not require a common dominant technique in which a plurality of coil segments are formed, inserted into slots, and thereafter, coil ends of the coil segments are welded. Thus, it is not necessary to use, for example, a high-purity copper material for the coil to be subjected to heat process at weld points, making it possible to use recycled copper material containing impurities and contribute to achievement of the recycling and reusing of resources.

The wave winding coil 1 described above includes the six coil wires 10 arranged in parallel to each other, but the number of the coil wires 10 arranged in parallel is not limited to six, and the number may be appropriately increased or reduced. The coil wires 10 includes the three unit wires 10a arranged in parallel to each other, but the number of the unit wires 10a is not limited to three, and the number may also be appropriately increased or reduced.

The wave winding coil is not limited to one formed from the coil wires 10 formed into a substantial U-shape, and the wave winding coil may be formed by alternatively performing the inclined part forming step and the folding step on the straight coil wire.

### EXPLANATION OF REFERENCE NUMERALS

1: Wave winding coil
10: Coil wire (conductor)
10a: Unit wire
11: In-slot disposition part
12: Turning part (Fold part)
12c: Apex part
20: Stator core
23: Slot
100: Group of conductors
225: Restrainer
225a: Groove

What is claimed is:

1. A conductor forming device which folds a group of conductors in thickness directions, the group of conductors including a plurality of conductors having straight parts, the conductor forming device comprising:
a restrainer provided with a plurality of grooves in which fold parts of the conductors each consisting of at least two unit wires are fitted and which limit a width of each of the conductors to a predetermined distance, when the conductors each consisting of the at least two unit wires are to be folded.

2. The conductor forming device according to claim 1, wherein
the plurality of grooves are arranged in parallel to each other at predetermined intervals in correspondence with the plurality of conductors disposed to be formed at the same time.

3. A method of manufacturing a wave winding coil from coil wire, the wave winding coil including a plurality of in-slot disposition parts to be disposed in slots of a stator core, and a turning part that couples the in-slot disposition parts adjacent to each other, the method comprising:
a folding step of forming the turning part by folding two or more unit wires at the same time in a state where a width of an apex part of the turning part consisting of the at least two unit wires is limited to a predetermined distance.

4. The method of manufacturing a wave winding coil according to claim 3, wherein
in the folding step, a plurality of the turning parts disposed to be formed at the same time are arranged in parallel to each other at predetermined intervals.
